(19) United States
(12) Patent Application Publication
(10) Pub. No.: US 2011/0115727 A1
(43) Pub. Date: May 19, 2011

(54) DISPLAY DEVICE AND TOUCH PANEL THEREOF

(75) Inventors: CHEN FENG, Beijing (CN); LI QIAN, Beijing (CN)

(73) Assignee: BEIJING FUNATE INNOVATION TECHNOLOGY CO., LTD., Beijing (CN)

(21) Appl. No.: 12/853,558

(22) Filed: Aug. 10, 2010

(30) Foreign Application Priority Data
Nov. 18, 2009 (CN) 200910223722.2

(51) Int. Cl. G06F 3/041

(52) U.S. Cl. 345/173; 977/952

(57) ABSTRACT

A touch panel includes a first electrode plate, a second electrode plate, and a continuous transparent insulating layer. The first electrode plate includes a first conductive layer. The second electrode plate includes a second conductive layer opposite to and spaced from the first conductive layer. The continuous transparent insulating layer is located between the first conductive layer and the second conductive layer. At least one of first conductive layer and the second conductive layer includes a carbon nanotube structure.

### CROSS-REFERENCE TO RELATED APPLICATIONS

This application claims all benefits accruing under 35 U.S.C. §119 from China Patent Application No. 200910223722.2, filed on 2009/11/18, in the China Intellectual Property Office, the disclosure of which is incorporated herein by reference.

### BACKGROUND

1. Technical Field

The disclosure relates to touch panels and, particularly, to a carbon nanotube-based touch panel and a display device incorporating the same.

2. Description of Related Art

Various electronic apparatuses such as mobile phones, car navigation systems and the like are equipped with optically transparent touch panels applied over display devices such as liquid crystal panels. The electronic apparatus is operated when contact is made with the touch panel corresponding to elements appearing on the display device. A demand thus exists for such touch panels to maximize visibility and reliability in operation.

Resistive, capacitive, infrared, and surface acoustic wave touch panels have been developed. Resistive and capacitive touch panels are widely applied because of the higher accuracy and low cost of production.

A resistive or capacitive touch panel often includes a layer of indium tin oxide (ITO) as an optically transparent conductive layer. The ITO layer is generally formed by ion beam sputtering, a relatively complicated undertaking. Furthermore, the ITO layer has poor wearability, low chemical endurance and uneven resistance over the entire area of the panel, as well as relatively low transparency. Such characteristics of the ITO layer can significantly impair sensitivity, accuracy, and brightness.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a touch panel.

FIG. 2 is a transverse assembled cross-section of the touch panel of FIG. 1.

FIG. 3 shows a Scanning Electron Microscope (SEM) image of a carbon nanotube film.

FIG. 4 is a schematic, enlarged view of a carbon nanotube segment in the carbon nanotube film of FIG. 3.

FIG. 5 shows an operating stage of a display device using the touch panel of FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

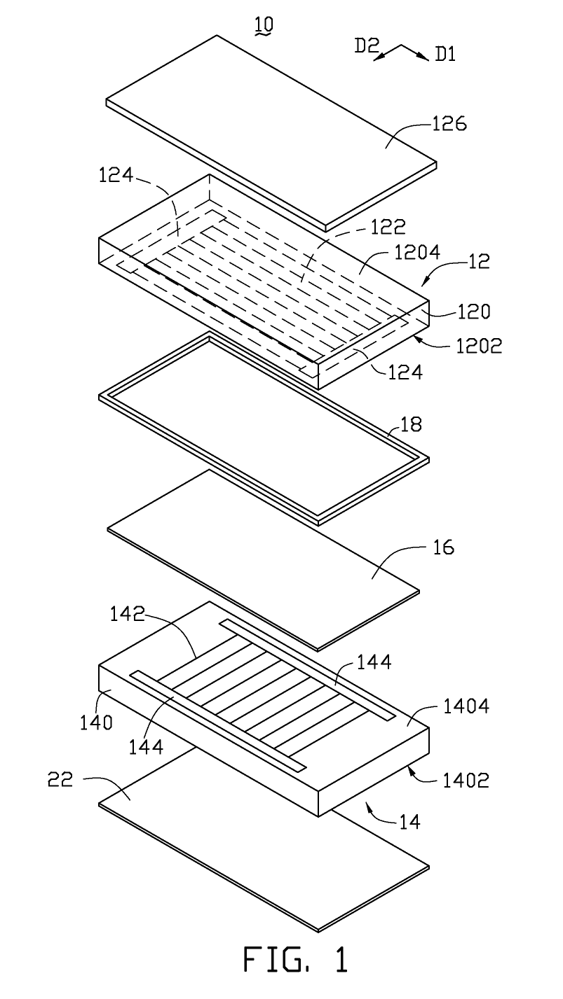

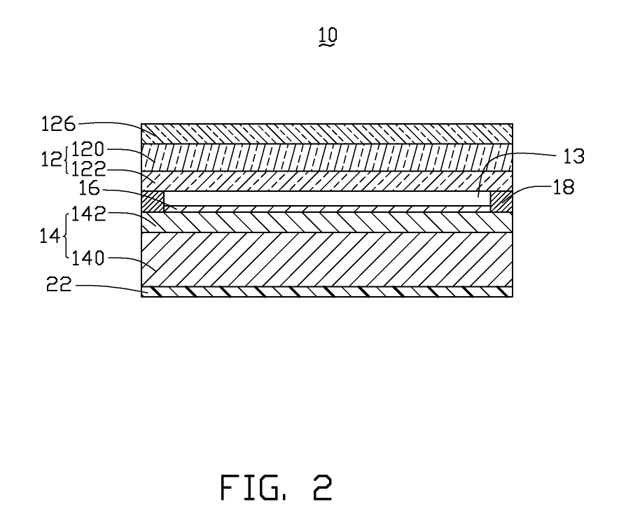

Referring to FIG. 1 and FIG. 2, one embodiment of a touch panel 10 comprises a first electrode plate 12, a second electrode plate 14, and a transparent insulating layer 16 located between the first electrode plate 12 and the second electrode plate 14.

The first electrode plate 12 includes a first substrate 120, a first conductive layer 122, and two first electrodes 124. The first substrate 120 includes a first surface 1202 and an opposite second surface 1204, each of which can be substantially flat. The first surface 1202 is opposite to and spaced from the second electrode plate 14. The first conductive layer 122 is adhered to the first surface 1202. The two first electrodes 124 are located separately on opposite ends of the first conductive layer 122 substantially along a first axis which is represented by the D1 axis shown in FIG. 1. The two first electrodes 124 electrically connect to the first conductive layer 122.

The second electrode plate 14 includes a second substrate 140, a second conductive layer 142, and two second electrodes 144. The second substrate 140 includes a first surface 1402 and an opposite second surface 1404, each of which can be substantially flat. The second surface 1404 is opposite to and spaced from the first electrode plate 12. The second conductive layer 142 is adhered to the second surface 1404. The two second electrodes 144 are located separately on opposite ends of the second conductive layer 142 substantially along a second axis which is represented by the D2 axis shown in FIG. 1. The two second electrodes 144 electrically connect to the second conductive layer 142. The first axis crosses with the second axis. In the embodiment shown in FIG. 1, the first axis is substantially perpendicular to the second axis.

The first substrate 120 is a transparent and flexible film/plate made of polymer, resin, or any other flexible material. The second substrate 140 is a transparent board made of glass, diamond, quartz, plastic or any other suitable material. The second substrate 140 can be made of flexible material. The flexible material can be polycarbonate (PC), polymethyl methacrylate acrylic (PMMA), polyethylene terephthalate (PET), polyether polysulfones (PES), polyvinyl polychloride (PVC), benzocyclobutenes (BCB), polyesters, or acrylic resins. The thickness of both of the first substrate 120 and the second substrate 140 can range from about 0.01 mm to about 1 cm. In this embodiment, the first substrate 120 is a polyester film, and the second substrate 140 is a glass board.

The first electrodes 124 and the second electrodes 144 can be made of electrically conductive materials, such as metal or carbon nanotubes. The first electrodes 124 and the second electrodes 144 can be directly formed respectively on the first conductive layer 122 and the second conductive layer 142, by sputtering, electroplating, or chemical plating. Alternatively, the first electrodes 124 and the second electrodes 144 can be adhered respectively to the first conductive layer 122 and the second conductive layer 142, with conductive adhesives. The first electrodes 124 can be disposed between the first substrate 120 and the first conductive layer 122, or be disposed on the first substrate 120. Similarly, the second electrodes 144 can be disposed between the second substrate 140 and the second conductive layer 142, or be disposed on the second substrate 140. In this embodiment, the first electrode 124 and the second electrode 144 are made of silver.

At least one of the first conductive layer 122 or the second conductive layer 142 can be or can include a carbon nanotube structure formed of a plurality of carbon nanotubes. The carbon nanotubes in the carbon nanotube structure can be orderly or disorderly arranged. The term ‘disordered carbon nanotube structure’ includes, but is not limited to, a structure where the carbon nanotubes are arranged along many different directions, arranged such that the number of carbon nanotubes arranged along each different direction can be almost the same (e.g. uniformly disordered), and/or entangled with each other. ‘Ordered carbon nanotube structure’ includes, but is not limited to, a structure where the carbon nanotubes are arranged in a systematic manner, e.g., the carbon nanotubes are arranged approximately along a same direction and or have two or more sections within each of which the carbon nanotubes are arranged approximately along a same direction (different sections can have different directions).

The carbon nanotubes in the carbon nanotube structure can be single-walled, double-walled, and/or multi-walled carbon nanotubes. The diameters of the single-walled carbon nanotubes can range from about 0.5 nanometers to about 50 nanometers. The diameters of the double-walled carbon nanotubes can range from about 1 nanometer to about 50 nanometers. The diameters of the multi-walled carbon nanotubes can range from about 1.5 nanometers to about 50 nanometers.

The carbon nanotube structure can comprise at least one carbon nanotube film, at least one linear carbon nanotube structure, and/or a combination thereof. If the carbon nanotube structure comprises a plurality of carbon nanotube films, the plurality of carbon nanotube films can be stacked together and/or coplanar arranged. If the carbon nanotube structure comprises a plurality of linear carbon nanotube structures, the plurality of linear carbon nanotube structures can be substantially parallel with each other (not shown), crossed with each other, or woven together. If the carbon nanotube structure comprises a plurality of linear carbon nanotube structures and a plurality of carbon nanotube films, the plurality of linear carbon nanotube structures can be disposed on at least one surface of the plurality of carbon nanotube films. Some examples of the carbon nanotube structure are given below.

### Drawn Carbon Nanotube Film

In one embodiment, the carbon nanotube structure can include at least one drawn carbon nanotube film. Examples of a drawn carbon nanotube film are taught by U.S. Pat. No. 7,045,108 to Jiang et al., and WO 2007015710 to Zhang et al.

The carbon nanotube drawn film includes a plurality of carbon nanotubes that can be arranged substantially parallel to a surface of the carbon nanotube drawn film. A large number of the carbon nanotubes in the carbon nanotube drawn film can be oriented along a preferred orientation, meaning that a large number of the carbon nanotubes in the carbon nanotube drawn film are arranged substantially along the same direction. An end of one carbon nanotube is joined to another end of an adjacent carbon nanotube arranged substantially along the same direction by Van der Waals attractive force. A small number of the carbon nanotubes are randomly arranged in the carbon nanotube drawn film, and has a small if not negligible effect on the larger number of the carbon nanotubes in the carbon nanotube drawn film arranged substantially along the same direction. The carbon nanotube film is capable of forming a free-standing structure. The term “free-standing structure” can be defined as a structure that does not have to be supported by a substrate. For example, a free standing structure can sustain the weight of itself when it is hoisted by a portion thereof without any significant damage to its structural integrity. So, if the carbon nanotube drawn film is placed between two separate supporters, a portion of the carbon nanotube drawn film, not in contact with the two supporters, would be suspended between the two supporters and yet maintain film structural integrity. The free-standing structure of the carbon nanotube drawn film is realized by the successive carbon nanotubes joined end to end by Van der Waals attractive force.

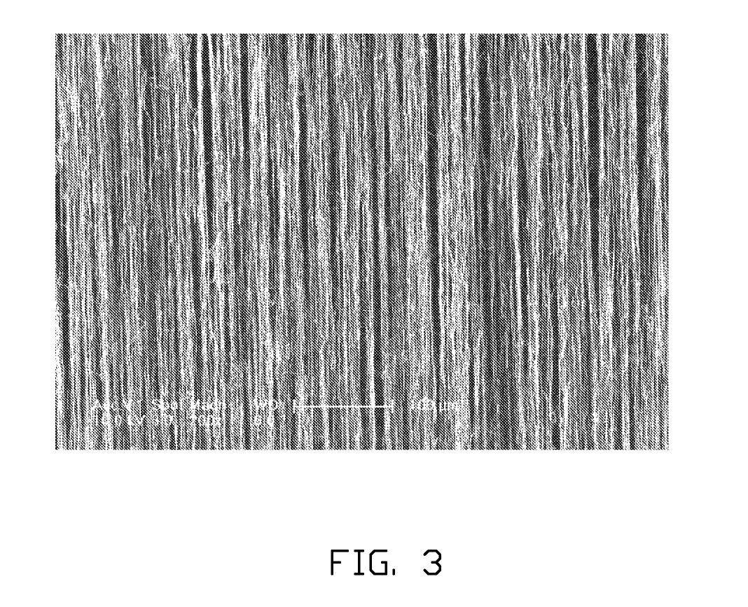

It can be appreciated that some variation can occur in the orientation of the carbon nanotubes in the carbon nanotube drawn film as can be seen in FIG. 3. Microscopically, the carbon nanotubes oriented substantially along the same direction may not be perfectly aligned in a straight line, and some curve portions may exist. It can be understood that some carbon nanotubes located substantially side by side and oriented along the same direction in contact with each other cannot be excluded.

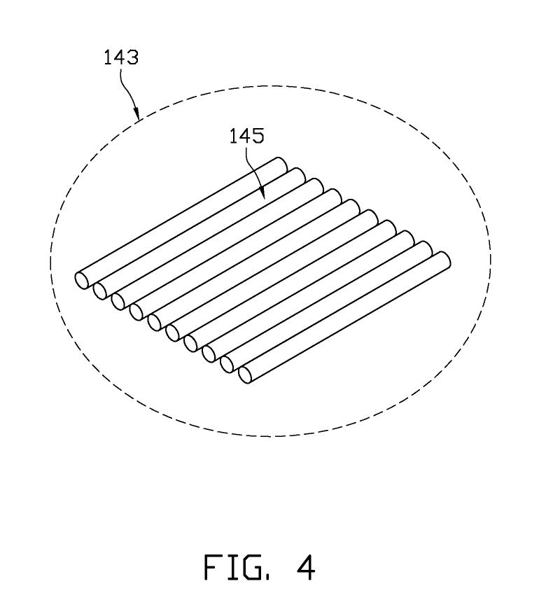

More specifically, referring to FIG. 4, the carbon nanotube drawn film includes a plurality of successively oriented carbon nanotube segments 143 joined end-to-end by Van der Waals attractive force therebetween. Each carbon nanotube segment 143 includes a plurality of carbon nanotubes 145 substantially parallel to each other, and joined by Van der Waals attractive force therebetween. The carbon nanotube segments 143 can vary in width, thickness, uniformity and shape. The carbon nanotubes 145 in the carbon nanotube drawn film 143 are also substantially oriented along a preferred orientation.

The carbon nanotube structure can also include at least two stacked drawn carbon nanotube films. In other embodiments, the carbon nanotube structure can include two or more coplanar drawn carbon nanotube films. Coplanar drawn carbon nanotube films can also be stacked upon other coplanar films. Additionally, an angle can exist between the orientation of carbon nanotubes in adjacent drawn films, stacked and/or coplanar. Adjacent drawn carbon nanotube films can be combined by only Van der Waals attractive forces therebetween without the need of an additional adhesive. An angle between the aligned directions of the carbon nanotubes in the two adjacent drawn carbon nanotube films can range from about 0 degrees to about 90 degrees.

The number of drawn carbon nanotube films is not limited, so long as the carbon nanotube structure has a proper light transmittance according to the actual needs. The light transmittance of the drawn carbon nanotube film can exceed 75%. The light transmittance of the drawn carbon nanotube film can exceed 90% after laser treatment.

### Pressed Carbon Nanotube Film

In other embodiments, the carbon nanotube structure can include at least a pressed carbon nanotube film. The pressed carbon nanotube film can be a free-standing carbon nanotube film. The carbon nanotubes in the pressed carbon nanotube film can be arranged along a same direction or along different directions. The carbon nanotubes in the pressed carbon nanotube film can rest upon each other. Adjacent carbon nanotubes are attracted to each other and combined by Van der Waals attractive force. An angle between a primary alignment direction of the carbon nanotubes and a surface of the pressed carbon nanotube film is about 0 degrees to approximately 15 degrees. The greater the pressure applied, the smaller the angle obtained. If the carbon nanotubes in the pressed carbon nanotube film are arranged along different directions, the carbon nanotube structure can be isotropic. Here, “isotropic” means the carbon nanotube film has properties identical in all directions substantially parallel to a surface of the carbon nanotube film. The thickness of the pressed carbon nanotube film can range from about 0.5 nm to about 1 mm. Examples of a pressed carbon nanotube film are taught by US PGPub. 20080299031A1 to Liu et al.

### Flocculated Carbon Nanotube Film

In other embodiments, the carbon nanotube structure can include a flocculated carbon nanotube film. The flocculated carbon nanotube film can include a plurality of long, curved, disordered carbon nanotubes entangled with each other. Further, the flocculated carbon nanotube film can be isotropic. The carbon nanotubes can be substantially uniformly dispersed in the carbon nanotube film. Adjacent carbon nanotubes are acted upon by Van der Waals attractive force to obtain an entangled structure with micropores defined therein. It is understood that the flocculated carbon nanotube film is very porous. The sizes of the micropores can be less than 10 μm. The porous nature of the flocculated carbon nanotube film will increase the specific surface area of the carbon nanotube structure. Because the carbon nanotubes in the carbon nanotube structure are entangled with each other, the carbon nanotube structure employing the flocculated carbon nanotube film has excellent durability, and can be fashioned into desired shapes with a low risk to the integrity of the carbon nanotube structure. The thickness of the flocculated carbon nanotube film can range from about 1 μm to about 1 mm.

### Carbon Nanotube Film of Ultra-Long Carbon Nanotubes

In other embodiments, the carbon nanotube structure can include a carbon nanotube film of ultra-long carbon nanotubes. Examples of a carbon nanotube film of ultra-long carbon nanotubes are taught by US PGPub. 20090197038A1 to Wang et al., and US PGPub. 20090297732A1 to Jiang et al. The carbon nanotube film comprises a plurality of ultra-long carbon nanotubes, the ultra-long carbon nanotubes are parallel to a surface of the carbon nanotube film and are parallel to each other. A length of the ultra-long carbon nanotube is approximately 1 centimeter or grater. In one embodiment, the length of the ultra-long carbon nanotube can be equal to the length of the carbon nanotube film, and opposite ends of at least one of the ultra-long carbon nanotubes can be opposite ends of the carbon nanotube film.

### Linear Carbon Nanotube Structure

In other embodiments, the carbon nanotube structure can include at least one linear carbon nanotube structure. The linear carbon nanotube structure can include one or more carbon nanotube wires. The carbon nanotube wires in the linear carbon nanotube structure can be substantially parallel to each other to form a bundle-like structure or twisted with each other to form a twisted structure.

The carbon nanotube wire can be an untwisted carbon nanotube wire or a twisted carbon nanotube wire. An untwisted carbon nanotube wire is formed by treating a carbon nanotube film with an organic solvent. The untwisted carbon nanotube wire includes a plurality of successive carbon nanotubes, which are substantially oriented along the linear direction of the untwisted carbon nanotube wire and joined end-to-end by Van der Waals attraction force therebetween. The untwisted carbon nanotube wire can have a diameter ranging from about 0.5 nm to about 1 mm. Examples of an untwisted carbon nanotube wire are taught by U.S. Pat. No. 7,045,108 to Jiang et al., and U.S. Pat. No. 7,704,480 to Jiang et al.

A twisted carbon nanotube wire can be formed by twisting a carbon nanotube film by a mechanical force. The twisted carbon nanotube wire includes a plurality of carbon nanotubes oriented around an axial direction of the twisted carbon nanotube wire. The length of the twisted carbon nanotube wire can be set as desired and the diameter of the carbon nanotube wire can range from about 0.5 nanometers to about 100 micrometers. The twisted carbon nanotube wire can be treated with an organic solvent before or after twisting.

In one embodiment, each of the first conductive layer 122 and the second conductive layer 142 is a single layer of drawn carbon nanotube film. The drawn carbon nanotube film has a length of about 30 cm, a width of about 30 cm, and a thickness of about 50 nm. The light transmittance of the drawn carbon nanotube film is about 90%. An angle between the aligned directions of the carbon nanotubes in the drawn carbon nanotube films of the first conductive layer 122 and the second conductive layer 142 can range from about 0 degrees to about 90 degrees. As shown in FIG. 1, the aligned direction of the carbon nanotubes in the drawn carbon nanotube films of the first conductive layer 122 is substantially parallel to the D1 axis. The aligned direction of the carbon nanotubes in the drawn carbon nanotube films of the second conductive layer 142 is substantially parallel to the D2 axis. The D1 axis is substantially perpendicular to the D2 axis.

Because the drawn carbon nanotube films have a high purity and a high specific surface area, the carbon nanotube films are adhesive. As such, the carbon nanotube films can be respectively adhered to the surfaces of the first substrate 120 and the second substrate 140 by their own adhesion. Alternatively, the carbon nanotube films can be adhered to the surfaces of the first substrate 120 and the second substrate 140 via adhesives such as polymethyl methacrylate acrylic (PMMA) or polyvinyl chloride (PVC), respectively.

The transparent insulating layer 16 is a continuous layer between the first electrode plate 12 and the second electrode plate 14. The transparent insulating layer 16 can cover the entire surface of the second conductive layer 142 to insulate the first conductive layer 122 from the second conductive layer 142. If a user presses the first electrode plate 12, the resulting deformation of the first electrode plate 12 causes a deformation of the transparent insulating layer 16. The deformation of the transparent insulating layer 16 causes a connection between the first conductive layer 122 and the second conduction layer 142. If the resulting deformation of the first electrode plate 12 disappears, the transparent insulating layer 16 restores to a former condition or position, so that the first conductive layer 122 and the second conductive layer 142 are insulated from each other by the transparent insulating layer 16. Further, an insulating frame 18 can be provided to ensure the first electrode plate 12 is insulated from the second electrode plate 14. The insulating frame 18 can be disposed around a periphery of the transparent insulating layer 16. The insulating frame 18 can be made of bonding materials such as epoxy glues.

The transparent insulating layer 16 can be made of polyethylene (PE), polyvinyl chloride (PVC), polystyrene, polymethyl methacrylate, purified water, terpilenol, propanol, methanol, ethanol, aether, carbon tetrachloride, white oil, oil of turpentine, olive oil, acetone, carbon bisulfide, glycerin, or trichloromethane. The light transmittance of the transparent insulating layer 16 can exceed about 85%. The light transmittance of the transparent insulating layer 16 can exceed about 95% in one embodiment.

The transparent insulating layer 16 can be in a liquid or solid state. If the transparent insulating layer 16 is in a solid state, the transparent insulating layer 16 can be a soft transparent film which can be directly positioned between the first conductive layer 122 and the second conductive layer 142. If the distance between the first electrode plate 12 and the second electrode plate 14 is in a range from about 2 μm to about 10 μm, the thickness of the transparent insulating layer 16 can be smaller than about 1 μm.

If the transparent insulating layer 16 is in a liquid state, the transparent insulating layer 16 can be sealed in a chamber 13 defined by the first electrode plate 12, the second electrode plate 14, and the insulating frame 18. More than about 75 percent and less than 100 percent of the chamber 13 is filled with the transparent insulating layer 16. In one embodiment, approximately 85 percent to approximately 96 percent of the chamber 13 is filled with the transparent insulating layer 16. At this condition, if the distance between the first electrode plate 12 and the second electrode plate 14 is in a range from about 2 μm to about 10 μm, the thickness of the transparent insulating layer 16 can range from about 1.5 μm to about 9 μm.

In this embodiment, the transparent insulating layer 16 is a PE film. The transparent insulating layer 16 faces the first conductive layer 122. The transparent insulating layer 16 has a thickness of about 0.2 μm in an axis from the first electrode plate 12 to the second electrode plate 14. The transparent insulating layer 16 has a light transmittance of about 90%. In the axis from the first electrode plate 12 to the second electrode plate 14, the transparent insulating layer 16 contacts with the second conductive layer 142 and is physically spaced from the first conductive layer 122. Because the transparent insulating layer 16 is a continuous layer, the transparent insulating layer 16 can provide a better insulation between the first electrode plate 12 and the second electrode plate 14 than conventional dot spacers.

The touch panel 10 can further comprise a transparent protective film 126 disposed on a top surface of the first electrode plate 12. The material of the transparent protective film 126 can be silicon nitride, silicon dioxide, BCB, polyester, acrylic resin, PET, or any combination thereof. The transparent protective film 126 can also be a plastic film with surface hardening treatment. The transparent protective film 126 can also provide some additional functions, such as reducing glare and reflection. In the present embodiment, the material of the transparent protective film 126 is PET.

The touch panel 10 can further comprise a shielding layer 22 disposed on the first surface 1402 of the second substrate 140. The shielding layer 22 and the second conductive layer 142 are disposed on opposite surfaces of the second substrate 140. The material of the shielding layer 22 can be ITO film, ATO film, conductive resin film, carbon nanotube film, or suitable conductive film. In this embodiment, the shielding layer 22 is a carbon nanotube film. The carbon nanotube film includes a plurality of carbon nanotubes, orientations of the carbon nanotubes therein can be arbitrarily determined. In this embodiment, the carbon nanotubes in the carbon nanotube film of the shielding layer 22 are arranged along the same axis. The carbon nanotube film is connected to ground and acts as shielding, thus enabling the touch panel 10 to operate without interference (for example, electromagnetic interference).

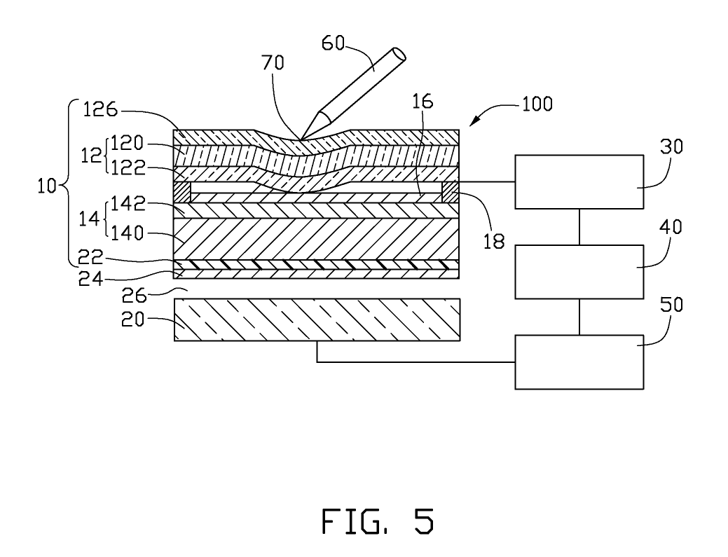

Referring to FIG. 5, one embodiment of a display device 100 using the above touch panel 10 is provided. The display device 100 can further comprise a display element 20, a touch panel controller 30, a central processing unit (CPU) 40, and a display element controller 50. The touch panel controller 30, the CPU 40, and the display element controller 50 are electrically connected. The touch panel controller 30 electrically connects with the touch panel 10. In particular, the CPU 40 is connected to the display element controller 50 to control the display element 20.

The display element 20 can be, for example, a conventional display such as a liquid crystal display, field emission display, plasma display, electroluminescent display, vacuum fluorescent display, cathode ray tube, or other display device, or a flexible display such as an e-paper (a microencapsulated electrophoretic display), a flexible liquid crystal display, a flexible organic light emitting display (OLED), or any other flexible display. In this embodiment, the display element 20 can be a liquid crystal display.

The touch panel 10 can be spaced from the display element 20 or installed directly on the display element 20. If the touch panel 10 is installed directly on the display element 20, the touch panel 10 can be attached on the display element 20 by an adhesive. Electrical connections between the touch panel 10 and the display element 20 can be provided through built-in ports (not shown). If the touch panel 10 is spaced from the display element 20, the display device 100 can further comprise a passive layer 24. The passive layer 24 is located on a surface of the shielding layer 22 and faces the display element 20. The passive layer 24 can be spaced from the display element 20 a certain distance 26 or can be installed on the display element 20. The passive layer 24 can protect the display element 20 from chemical or mechanical damage. The passive layer 24 can be made of benzocyclobutene (BCB), polyester, or acrylics.

In operation of the display device 100, a voltage of about 5V is applied to the first electrode plate 12 and the second electrode plate 14. Contact is made with the first electrode plate 12 by pressing elements appearing on the display element 20 with a tool 60 such as a finger, pen, or stylus. The resulting deformation 70 of the first electrode plate 12 causes a connection between the first conductive layer 122 and the second conduction layer 142. Changes in voltages in the D1 axis of the first conductive layer 122 and the D2 axis of the second conductive layer 142 are detected by the touch panel controller 30 and sent to the CPU 40 to calculate the position of the deformation 70. The display element 20 shows desired information under the control of the display element controller 50 and the CPU 40.

Because the carbon nanotube film has high transparency, brightness of the touch panel and the display device using the same are enhanced. The carbon nanotubes provide superior strength, mechanical integrity, and uniform conductivity to the carbon nanotube film. Accordingly, the touch panel and display device using the carbon nanotube film are durable and highly conductive. Finally, because the transparent insulating layer is a continuous layer, the transparent insulating layer can provide a better insulation between the first electrode plate and the second electrode plate than the conventional dot spacers.

It is to be understood that the described embodiments are intended to illustrate rather than limit the disclosure. Any elements described in accordance with any embodiments is understood that they can be used in addition or substituted in other embodiments. Embodiments can also be used together. Variations may be made to the embodiments without departing from the spirit of the disclosure. The disclosure illustrates but does not restrict the scope of the disclosure.

What is claimed is:

1. A touch panel comprising:
a first electrode plate comprising a first conductive layer;
a second electrode plate comprising a second conductive layer opposite to and spaced from the first conductive layer; and
a continuous transparent insulating layer located between the first conductive layer and the second conductive layer, wherein at least one of the first conductive layer and the second conductive layer comprises a carbon nanotube structure.

2. The touch panel of claim 1, wherein the transparent insulating layer is made of polyethylene (PE), polyvinyl chloride (PVC), polystyrene, polymethyl methacrylate, purified water, terpilenol, propanol, methanol, ethanol, aether, carbon tetrachloride, white oil, oil of turpentine, olive oil, acetone, carbon bisulfide, glycerin, or trichloromethane.

3. The touch panel of claim 1, wherein a distance between the first electrode plate and the second electrode plate is larger than a thickness of the transparent insulating layer from the first electrode plate to the second electrode plate.

4. The touch panel of claim 1, further comprising an insulating frame disposed around a periphery of the transparent insulating layer and located between the first electrode plate and the second electrode plate.

5. The touch panel of claim 1, wherein the transparent insulating layer is in a liquid state, and the transparent insulating layer is sealed between the first electrode plate and the second electrode plate.

6. The touch panel of claim 5, further comprising an insulating frame located between the first electrode plate and the second electrode plate, wherein the insulating frame, the first electrode plate and the second electrode plate together define a chamber, and the transparent insulating layer is sealed in the chamber.

7. The touch panel of claim 6, wherein more than about 75 percent and less than 100 percent of the chamber is filled with the transparent insulating layer.

8. The touch panel of claim 6, wherein approximately 85 percent to approximately 96 percent of the chamber is filled with the transparent insulating layer.

9. The touch panel of claim 6, wherein a distance between the first electrode plate and the second electrode plate is in a range of from about 2 μm to about 10 μm, and a thickness of the transparent insulating layer ranges from about 1.5 μm to about 9 μm.

10. The touch panel of claim 1, wherein the transparent insulating layer is a soft transparent film directly positioned between the first conductive layer and the second conductive layer.

11. The touch panel of claim 10, wherein a distance between the first electrode plate and the second electrode plate is in a range from about 2 μm to about 10 μm, a thickness of the transparent insulating layer is smaller than 1 μm.

12. The touch panel of claim 1, wherein the carbon nanotube structure comprises at least one carbon nanotube film, at least one linear carbon nanotube structure, or a combination thereof.

13. The touch panel of claim 1, wherein the first electrode plate further comprises a first substrate and two spaced first electrodes, and the first conductive layer is disposed on the first substrate and electrically connects with the first electrodes; the second electrode plate further comprises a second substrate and two spaced second electrodes, and the second conductive layer is disposed on the second substrate and electrically connects with the second electrodes; the carbon nanotube structure is a carbon nanotube film of substantially parallel ultra-long carbon nanotubes; opposite ends of at least one of the ultra-long carbon nanotubes connect with the first electrodes and second electrodes, respectively.

14. A touch panel comprising:
a first electrode plate comprising a first conductive layer;
a second electrode plate comprising a second conductive layer opposite to and spaced from the first conductive layer; and
a transparent insulating layer covering substantially an entire surface of the second electrode plate and spaced from the first conductive layer; wherein at least one of the first conductive layer and the second conductive layer comprises a carbon nanotube structure.

15. The touch panel of claim 14, wherein the transparent insulating layer is a continuous layer.

16. The touch panel of claim 14, further comprising an insulating frame located between the first electrode plate and the second electrode plate, wherein the insulating frame, the first electrode plate, and the second electrode plate together define a chamber, and the transparent insulating layer is sealed in the chamber.

17. A display device comprising:
a touch panel comprising:
a first electrode plate comprising a first conductive layer;
a second electrode plate comprising a second conductive layer;
a first continuous transparent insulating layer located on the second conductive layer; and
a second continuous transparent insulating layer located on the first continuous transparent insulating layer and adjacent to the first conductive layer, the first continuous transparent insulating layer being different from the second continuous transparent insulating layer.

18. The display device of claim 17, wherein the first continuous transparent insulating layer is made of polythene (PE), polyvinyl chloride (PVC), polystyrene, polymethyl methacrylate, purified water, terpilenol, propanol, methanol, ethanol, aether, carbon tetrachloride, white oil, oil of turpentine, olive oil, acetone, carbon bisulfide, glycerin, or trichloromethane.

19. The display device of claim 18, wherein the second continuous transparent insulating layer is a layer of air.

20. The display device of claim 18, wherein the second continuous transparent insulating layer is a vacuum gap.
